(19) United States
(12) Patent Application Publication
(10) Pub. No.: US 2018/0082342 A1
(43) Pub. Date: Mar. 22, 2018

(54) PREDICTING AUTOMOBILE FUTURE VALUE AND OPERATIONAL COSTS FROM AUTOMOBILE AND DRIVER INFORMATION FOR SERVICE AND OWNERSHIP DECISION OPTIMIZATION

(71) Applicant: INTERNATIONAL BUSINESS MACHINES CORPORATION, Armonk, NY (US)

(72) Inventors: Amos CAHAN, Dobbs Ferry, NY (US); Guy M. COHEN, Ossining, NY (US); Lior HORESH, North Salem, NY (US); Raya HORESH, North Salem, NY (US)

(21) Appl. No.: 15/271,601

(22) Filed: Sep. 21, 2016

(51) Int. Cl. G06Q 30/02

(52) U.S. Cl. CPC G06Q 30/0278

(57) ABSTRACT

Predicting automobile future value and operational costs includes obtaining ownership and maintenance determinative factors for an automobile and an operator profile for an automobile operator. The ownership and maintenance determinative factors include operational parameters and maintenance parameters affecting ownership costs and automobile value for the automobile, and the operator profile for an automobile operator describes automobile operating conditions attributable to the automobile operator. At least one of the ownership and maintenance determinative factors and the operator profile is used to predict future value and operational costs for the automobile owned and operated by the operator.

### FIELD OF THE INVENTION

The present invention relates to automobile maintenance and automobile valuation as they apply to an automobile owner.

### BACKGROUND OF THE INVENTION

Vehicles are equipped with computers that monitor the function of various car components, including the engine, transmission and safety systems. These computers can be interrogated by special devices to provide diagnostic information including component malfunction and requirement component replacement. This diagnostic information is used by mechanics to identify systems to be checked and parts to be replaced. Manufacturers of these vehicles also collect information on mechanical and electrical problems associated with their vehicles. For example, these mechanical and electrical problems are identified when vehicles are serviced in particular under warranty claims. During the associated service visit, the vehicle computer is interrogated, and the obtained information is collected and stored for analysis by the manufacturer. The resulting analysis is used by the manufacturer to identify, for example, potential recalls or advisable preemptive component replacement, for example, of components having a high rate of failure. This analysis is also used to develop and update service guidelines provided to mechanics.

Decisions about automobile maintenance and ownership may be influenced by owner preferences, individual car use patterns and users' driving habits. Manufacturer information about failure rates of mechanical or electrical components in vehicles is not publically available. Reliability and quality in third party reviews and reports is often based on collecting information from mechanics through interviews or collecting reports from owners of the vehicles. The collected information, however, is high-level, incomplete and often biased. Therefore, a need exist to provide end consumers with reliable information on the nature and frequency of mechanical and electrical problems in the exact model of vehicle and a mileage and age of the vehicle experiencing the mechanical and electrical problems to allow consumers to make informed purchasing decisions. Information and insights should also be individualized by taking into account user driving habits and patterns of use.

### SUMMARY OF THE INVENTION

Exemplary embodiments are directed to systems and methods for collecting, transmitting, analyzing and presenting information relevant to vehicle ownership and service decisions. In one embodiment, a device is provided to collect information from vehicle computers and to communicate and share the collected information. Methods are provided to analyze reports from different vehicle owners to provide summary statistics and individualized predictions and recommendations about service and vehicle ownership. In one embodiment, a device capable of reading information from one or more on-board vehicle computers that collect information about the performance of mechanical and electrical components is functionally connected to one or more additional computers that are external to the vehicle and that are in contact with the on-board computers. The collected information read by the collection device is transmitted, for example wirelessly, to a remote computer such as a computer or server in a cloud based computing system. The collected information can be communicated to the cloud based computer or server directly or through an additional computing device coupled to the cloud based computer, e.g., a user smartphone. Data collected by the collection device include, but are not limited to, vehicle mileage, vehicle age, an identification of the malfunction part, component or system and an identification of replaced parts, components or systems. The collected information or data are transmitted to the remote computer. The data can be collected and transmitted continuously or intermittently in discrete batches.

Data received at the remote computer from multiple users is analyzed and a list is generated for a given vehicle, vehicle model or vehicle part. The list includes an identification of the types of faults reporting or experienced with that vehicle, model or part. In one embodiment, the list is a ranked list. The list can be ranked, for example, by frequency. In addition, the rate of failure or malfunction may be adjusted for factors such as time since manufacturing, i.e., age, time since first use, time since last replacement, engine hours or vehicle mileage at time of the failure or malfunction. In one embodiment, cost data, e.g., cost of replacement parts and repair service can be obtained from available databases. Cost data can be included in the list. In one embodiment, data on new and used car cost corrected for geographical region and other determinants are collected from publicly available databases. In a preferred embodiment, data about patterns of vehicle use, including area (e.g. urban or rural, plain or mountainous, zipcode, use of salt on nearby roads), surrounding traffic (e.g. traffic jams), and driving patterns (e.g. intensity of acceleration and break use, average and maximal speed, average length of each ride, etc.) is also collected.

The collected data are used to train prediction models. The prediction models use machine learning to predict the risk for a given fault occurring in a given vehicle, model or part within a given time or at a given mileage. In one embodiment, the prediction models also provide a total predicted cost of parts and service within a certain time window or within a certain mileage. In one embodiment, the prediction models are provided in an interactive system through which a user or consumer can evaluate or obtain the predicted costs of owning a user selected vehicle model. In one embodiment, the interactive system provides a graphic environment to display the predicted costs of multiple vehicle models and years for comparison purposes. The interactive system can provide information to a user or consumer regarding the timing or mileage associated with repairs that a consumer can user to decide whether to purchase a given vehicle and at what point to sell a vehicle that the consumer may own, e.g., before known issues occur or expected costly repairs are required.

Exemplary embodiments are directed to a method for predicting automobile future value and operational costs. Ownership and maintenance determinative factors are obtained for an automobile. The ownership and maintenance determinative factors include operational parameters and maintenance parameters affecting ownership costs and automobile value for the automobile. In one embodiment, ownership and maintenance determinative factors are obtained for the automobile and for individual components of the automobile. In one embodiment, at least one of a chronological vehicle age and a vehicle mileage is associated with at least one ownership and maintenance determinative factor. In one embodiment, the maintenance parameters include a history of warranty claims for the automobile, a history of factory recalls for the automobile, service records for the automobile, cost of components for the automobile, environmental conditions where the automobile is physically located, third-party reviews of the automobile, owner reviews of the automobile, data logs from computers and sensors contained in the automobile, reliability data and combinations thereof. In one embodiment, the operational parameters comprise fuel consumption data, type of fuel, licensing costs, personal property taxes, insurance costs, vehicle inspection costs, scheduled maintenance and combinations thereof.

In addition, an operator profile is obtained for an automobile operator describing automobile operating conditions attributable to the automobile operator. In one embodiment, the operator profile includes demographic data, driving record, yearly mileage driven, average automobile speed, mean automobile speed, automobile speed profile, automobile acceleration profile, automobile breaking profile, gas pedal use, lane crossing and overtaking, geographical data, municipal data, percentage of highway miles, percentage of city miles, percentage of time spent in traffic, average number of occupants in the automobile and combinations thereof.

At least one of the ownership and maintenance determinative factors and the operator profile is used to predict future value and operational costs for the automobile owned and operated by the operator. In one embodiment, obtaining ownership and maintenance determinative factors includes obtaining ownership and maintenance factors for a plurality of automobiles and the ownership and maintenance determinative factors and the operator profile for the plurality of automobiles are used to predict future value and operational costs for each one of the plurality of automobiles owned and operated by the operator. In one embodiment, obtaining the operator profile further includes obtaining an operator profile for each one of a plurality of automobile operators describing automobile operating conditions attributable to each automobile operator, and the operator profiles for the plurality of automobile operators are used to predict future value and operational costs for the automobile owned and operated by each one of the plurality of operators.

In one embodiment, at least one of obtaining ownership and maintenance determinative factors and obtaining the operator profile further includes at least one of interrogating computers and sensors contained in the automobile using a portable electronic device and recording automobile operating conditions attributable to the operator in real time using the portable electronic device. In addition, the portable electronic device is used to communicate data obtained from the computers and sensors and the automobile operating conditions to a database. In one embodiment, using the ownership and maintenance determinative factors and the operator profile to predict future value and operational costs includes predicting future value and operational costs by at least one of automobile mileage and automobile age.

In one embodiment, the predicted future value and operational costs are used to decide whether to purchase the automobile, repair the automobile or dispose of the automobile. In one embodiment, the ownership and maintenance determinative factors and the operator profile are used to provide a recommended maintenance regime and modification to the operator profile that increase future value of the automobile, reduce maintenance costs for the automobile and reduce operational costs for the automobile owned and operated by the operator.

Exemplary embodiments are also directed to a computing system for predicting automobile future value and operational costs. The computing system includes a hardware memory containing a database with ownership and maintenance determinative factors for an automobile. The ownership and maintenance determinative factors include operational parameters and maintenance parameters affecting ownership costs and automobile value for the automobile. The database also includes an operator profile for an automobile operator describing automobile operating conditions attributable to the automobile operator. The computing system includes a processing unit in communication with the memory and a future value and operational cost prediction module to use at least one of the ownership and maintenance determinative factors and the operator profile to predict future value and operational costs for the automobile owned and operated by the operator.

In one embodiment, the computing system includes a vehicle maintenance and operation extractor. The extractor includes computers and sensors contained in the automobile to record operational parameters and maintenance parameters for the automobile, a portable electronic device to interrogate the computers and sensors to obtain the recorded operational parameters and maintenance parameters and to record automobile operating conditions attributable to the operator in real time using the portable electronic device and a central database in communication with the portable electronic device to receive the operational parameters, maintenance parameters and operating conditions.

### BRIEF DESCRIPTION OF THE DRAWINGS

FIG. 1 is a flow chart illustrating an embodiment of a method for predicting automobile future value and operational costs;

FIG. 2 is a schematic representation of an embodiment of a computing system for predicting automobile future value and operational costs;

FIG. 3 depicts a cloud computing environment according to an embodiment of the present invention; and

FIG. 4 depicts abstraction model layers according to an embodiment of the present invention.

### DETAILED DESCRIPTION

Exemplary embodiments provide for the collecting and analyzing of automobile maintenance and operational information in addition to operator specific information to support decisions by an owner and user of an automobile regarding ownership, insurance, repair and service. Relevant data on the maintenance and operation of an automobile are collected from a plurality of sources and can be provided, for example, to centralized databases and computer systems. Suitable sources of data include, but are not limited to publicly available or private databases, costs of replacement parts, input from multiple vehicles, surveys such including customer satisfaction surveys, automobile diagnostic information recorded by on-board computers and sensors and extracted from the computers, reports from dealer service centers and third party service centers, service recommendations and service memos from the automobile manufacturer and cost information from insurance companies. In general, the collected data relate to the maintenance and operational costs associated with a given automobile or model of automobile as well as the automobile operating conditions attributable to a given operator of the automobile. Therefore, both automobile specific and operator specific data are collection. As used herein, automobile covers any type of motorized or propel vehicle control or driven by an operator including cars, trucks, vans, motorcycles, buses, airplanes, boats, ships and personal water craft. The obtained data can cover a single automobile, a plurality of automobiles, a single operator, a plurality of operators and any combination thereof.

Having obtained the desired data for at least one automobile and at least one operator, the collected data are sorted for example, by automobile make, by automobile model, by automobile component name, by automobile part number and by operator. The collected automobile maintenance and operational data also include automobile mileage data and chronological time data, i.e., elapsed time since the manufacture of the automobile or component, in order to estimate a probability for a given automobile or automobile components to malfunction based on at least one of mileage and time or age. The collected data are analyzed to predict future value of the automobile and cost of ownership in terms of service, repairs, loss of work days, vehicle value decrease, among others. These predictions are specific to a given automobile and to a given operator of the automobile. Therefore, the predictions are provided to the operator for one or more vehicles so that the operator can use these predictions is making decisions regarding the purchase of a given automobile, the authorization of service for a given automobile and the disposal of an automobile that is already owned by the operator. As the prediction mechanism is specific to a given operator and also takes into account operator specific operating conditions, i.e., how an operator drives, where and under what circumstances the vehicle is used, recommendations are also made to the operator regarding how the operator can modify the operator-attributable operating or driving conditions to reduce maintenance costs, reduce automobile operational costs and increase automobile value.

Exemplary embodiments are also directed to computing systems and devices for collecting and analyzing of automobile maintenance and operational information in addition to operator specific information to support decisions by an owner and user of an automobile regarding ownership, insurance, repair and service. Suitable computing systems include distributed computing systems. In one embodiment, a device, e.g., an extractor, is provided to extract and transmit vehicle-related diagnostic information and operator specific operating conditions of the automobile. This device includes the on-board computers and sensors of the automobile, a portable electronic device associated with the operator that is in communication with the on-board computers and at least one database such as a central database in communication with the portable electronic device. The computers of the automobile are in communication with then portable electronic device either through a wired, e.g., USB, or wireless connection, e.g., WIFI or Bluetooth. Therefore, the computers and portable electronic devices include the transmitter and receiver components required to make this wireless connection.

Suitable portable electronic devices include laptop computers, tablet computers, personal digital assistants, netbooks, cellular phones including smartphones and customized interrogation computing systems. The on-board computers can also be interrogated by computing systems and telemetry systems located in a garage, at a tool booth or along a road or highway. When the portable electronic device is a smartphone, the data extractor utilizes all of the data collection systems, e.g., camera, microphone, accelerometers and gyroscopes, and communication systems of the smartphone. The portable electronic device is functionally connected to the onboard automobile computer systems and receives data from various sensors monitoring the function of vehicle systems. These data are then transmitted, preferably wirelessly, to a remote or central computer, for example using WiFi or cellular communication systems. In one embodiment, a home or business-based wireless network is used for the desired communication. The extractor can utilize external power sources or existing power sources of the automobile and portable electronic devices.

In addition to interrogating the onboard computing systems of the automobile in order to obtain the desired operational and maintenance information, the portable electronic devices can also be used to generate the operator specific operating conditions. These operating conditions can be generated in the automobile from which the maintenance and operational information is being obtained or in any automobile that is driven by the operator. The portable electronic device uses sensors such as accelerometers, navigation systems and global positioning systems, to analyze when, when and how the operator drives the automobile, or any automobile. This information, i.e., the automobile operating conditions attributable to the operating, are communicated to the central database and are used in formulating an operator profile. The operator profile is utilized in predicting maintenance costs, operating costs and automobile value.

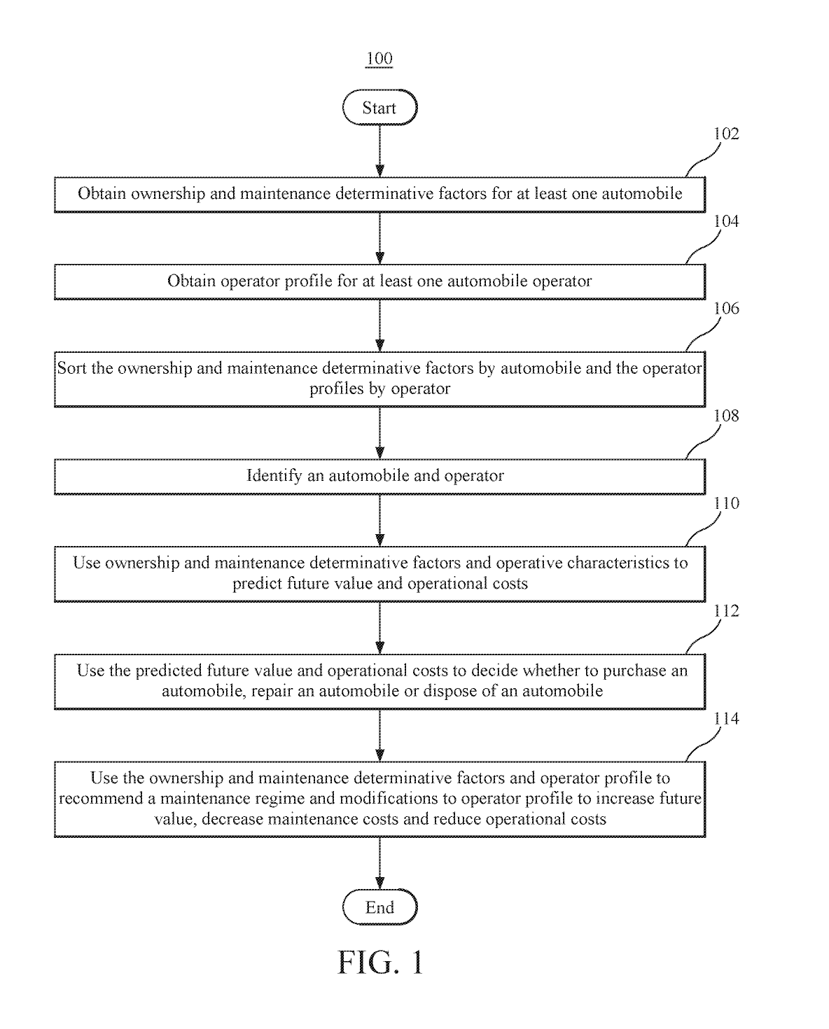

Referring initially to FIG. 1, a method for predicting automobile future value and operational costs 100 is illustrated. Ownership and maintenance determinative factors are obtained for at least automobile 102, automobile model or automobile component. In one embodiment, ownership and maintenance determinative factors are obtained for a plurality of different automobiles, automobile models and automobile components. The ownership and maintenance determinative factors include both operational parameters and maintenance parameters of the automobile. These operational parameters and maintenance parameters are relevant to and affect ownership costs and automobile value for the automobile. In general, maintenance parameters describe and summarize the need for and cost of maintenance services and repairs for the automobile. These can include both schedule maintenance events and unscheduled repairs that result from malfunctions in the automobile or components of the automobile. Suitable maintenance parameters include, but are not limited to, a history of warranty claims for the automobile, a history of factory recalls for the automobile, service records for the automobile, cost of components for the automobile, environmental conditions where the automobile is physically located, third-party reviews of the automobile, owner reviews of the automobile, data logs from computers and sensors contained in the automobile, reliability data and combinations thereof. Each maintenance parameters are associated with a given automobile or automotive component. In one embodiment, each obtained maintenance parameter is associated with an automobile mileage or a chronological time, i.e., chronological age of the automobile or automobile component. The maintenance parameters are saved or stored in one or more local or central databases.

The operational parameters describe costs associated with the normal operation of the automobile. Suitable operational parameters include, but are not limited to fuel consumption data, type of fuel, licensing costs, personal property taxes, insurance costs, vehicle inspection costs, scheduled maintenance or combinations thereof. Therefore, the operational parameters can be used to determine the costs associated with operating the automobile absent unexpected repairs. These operational parameters are automobile, automobile model or automobile component specific. Each operational parameter is associated with a given automobile or automotive component. In one embodiment, each operational parameter is associated with an automobile mileage or a chronological time, i.e., chronological age of the automobile or automobile component. The operational parameters are saved or stored in one or more local or central databases.

An operator profile is obtained for at least one automobile operator 104. Alternatively, an operator profile is obtained for each one of a plurality of automobile operators. Any given operator profile describes automobile operating conditions attributable to the automobile operator, regardless of the automobile that is actually being operated. Therefore, an operator profile can be obtained for a given operator based upon data obtained for the operator from two or more automobiles, regardless of whether or not ownership and maintenance determinative factors exist or have been obtained for that automobile. Suitable operator characteristics, include, but are not limited to, demographic data (including age and gender), driving record, yearly mileage driven, average automobile speed, mean automobile speed, automobile speed profile, automobile acceleration profile, e.g., fast or slow, automobile breaking profile, e.g., fast or slow, geographical data, percentage of highway miles, percentage of city miles, traffic congestion, and combinations thereof. In one embodiment, the operator profile includes demographic data, driving record, yearly mileage driven, average automobile speed, mean automobile speed, automobile speed profile, automobile acceleration profile, automobile breaking profile, gas pedal use, lane crossing and overtaking, geographical data, municipal data, e.g. statistics on use of salt on roads, percentage of highway miles, percentage of city miles, percentage of time spent in traffic, average number of occupants in the automobile, for example as detected through the use of safety belts in the rear seat and combinations thereof. Therefore, conditions that can affect the maintenance and operation of the automobile along with costs and reliability, e.g., how the operator operates the automobile and in what type of physical environment the automobile is operated, are also considered. The operator profile is saved or stored in one or more local or central databases.

Therefore, both automobile specific and operator specific factors are taken into consideration when formulating the costs or ownership and operation of any given automobile owned and operated by any given operator. Exemplary embodiments create a more robust predictive system that stores data on multiple automobiles and multiple operators. In one embodiment, an operator profile is obtained for each one of a plurality of automobile operators describing automobile operating conditions attributable to each automobile operator. In one embodiment, ownership and maintenance determinative factors are obtained for a plurality of automobiles.

The ownership and maintenance determinative factors and operator profiles can be obtained from any available databases including web-based databases, proprietary database, public database, government databases, third party databases, manufacturer databases, data submitted directly from owners, manufacturers and third parties, responses to surveys, manufacturer websites, automobile component websites and automobile testing and review websites. ownership and maintenance determinative factors and operator profiles can also be obtained directly from the automobiles, automobile components and operators. In one embodiment, at least one of obtaining ownership and maintenance determinative factors and obtaining the operator profile is conducted using onboard computers and sensors in combination with a portable computing device associated with the operator and one or more databases including a central database.

In accordance with this embodiment, the computers and sensors contained in the automobile are interrogated using a portable electronic device. Suitable portable electronic devices include laptop computers, tablet computers, personal digital assistants, netbooks, cellular phones including smartphones and customized interrogation computing systems. This interrogation can be conducted automatically, for example, each time the portable electronic device establishes communication with the onboard electronics of the automobile. Alternatively, interrogation is conducted in response to a command from the operator. The portable electronic device can include a software program or application that provides for establishing communication with the onboard computer, interrogating the computer to obtain ownership and maintenance determinative factors, and communicating the obtained data to the database. In general, the existing communication and data generation systems of the portable electronic device are utilized in the computer interrogation, data capture and data upload to the central database. These existing communication and data generation systems are also used to generate data for the operator profile, regardless of the automobile being operated. In one embodiment, automobile operating conditions attributable to the operator are recorded in real time using the portable electronic device. Therefore, the portable electronic device is used to communicate data obtained from the computers and sensors and the recorded automobile operating conditions to the database.

When the ownership and maintenance determinative factors and operator profiles are obtained for multiple automobiles, multiple automobile components and multiple operators, the obtained ownership and maintenance determinative factors and operator profiles are sorted by automobile, automobile component and operator 106 before being stored in one or more databases. Then, the automobile and operator for which predicted automobile future value and operational costs are desired are identified 108.

Then, at least one of the ownership and maintenance determinative factors and the operator characteristics from the operator profile are used to predict future value and operational costs 110 for the automobile owned and operated by the operator. In one embodiment, operator profiles for the plurality of automobile operators are used to predict future value and operational costs for an automobile owned and operated by each one of the plurality of operators. In another embodiment, ownership and maintenance factors for a plurality of automobiles are used to predict future value and operational costs for each one of the plurality of automobiles owned and operated by a given operator.

In one embodiment, the future value and operational costs are predicted based on at least one of automobile mileage and automobile age. The predicted future value and operational costs are displayed or provided to the operator, for example, on the portable electronic device, and are used by the operator to decide whether to purchase the automobile, repair the automobile or dispose of the automobile, i.e., an automobile already owned by the operator. In addition, the ownership and maintenance determinative factors and the operator characteristics are used to provide a recommended maintenance regime and modification to the operator characteristics, i.e., operator profile including driving habits, that increase future value of the automobile, reduce maintenance costs for the automobile and reduce operational costs 114 for the automobile owned and operated by the operator.

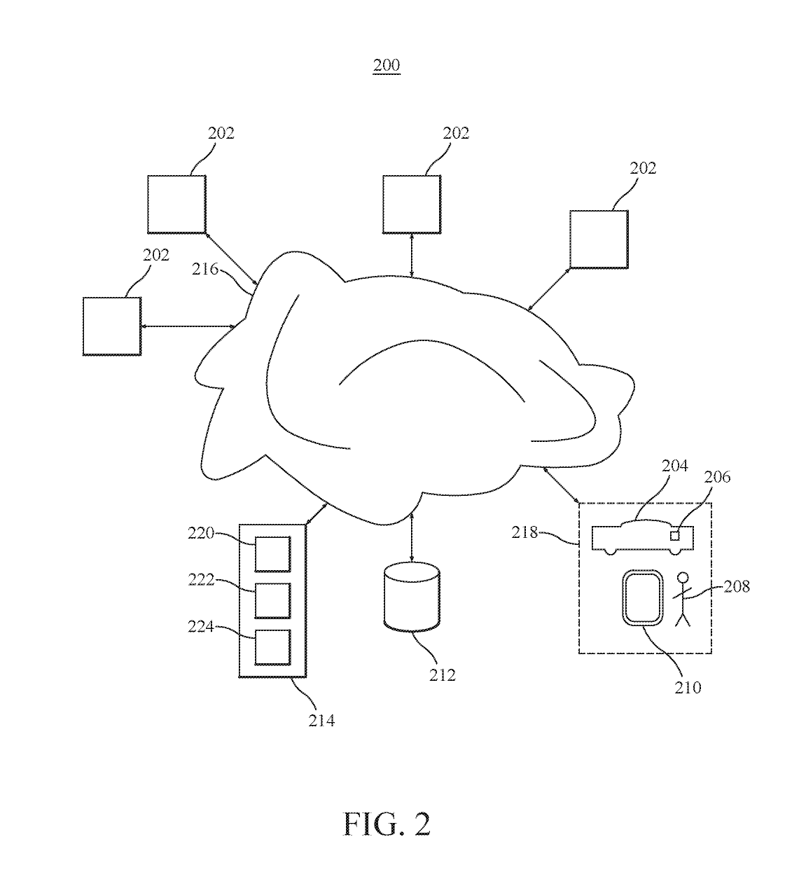

Referring now to FIG. 2, a computing system 200 for predicting automobile future value and operational costs is illustrated. Suitable computing systems include distributed computing systems, and the computing system includes all of the storage, data sources and computing resources for providing the predicted values and costs. As illustrated, the computing system includes are least one hardware memory 212 containing at least one database. Alternatively, a plurality of hardware memories is provided. In one embodiment, a single central memory containing a single central database is used. The database includes a plurality of comprising ownership and maintenance determinative factors for an automobile. The ownership and maintenance determinative factors include operational parameters and maintenance parameters affecting ownership costs and automobile value for the automobile. The maintenance parameters include a history of warranty claims for the automobile, a history of factory recalls for the automobile, service records for the automobile, cost of components for the automobile, environmental conditions where the automobile is physically located, third-party reviews of the automobile, owner reviews of the automobile, data logs from computers and sensors contained in the automobile, reliability data and combinations thereof, and the operational parameters include fuel consumption data, type of fuel, licensing costs, personal property taxes, insurance costs, vehicle inspection costs, scheduled maintenance or combinations thereof.

The database also includes at least one operator profile for an automobile operator describing automobile operating conditions attributable to the automobile operator. The operator characteristics comprise demographic data, driving record, yearly mileage driven, average automobile speed, mean automobile speed, automobile speed profile, automobile acceleration profile, automobile breaking profile, geographical data, percentage of highway miles, percentage of city miles and combinations thereof. In one embodiment, the database also stores at least one of a chronological vehicle age and a vehicle mileage with at least one ownership and maintenance determinative factor.

The computing system also includes a plurality of data sources 202 from which the ownership and maintenance determinative factors and operator profiles can be obtained. The computing system includes at least one extractor 218 to extract and transmit vehicle-related diagnostic information and operator specific operating conditions of the automobile 204. The extractor includes the on-board computers and sensors 206 of the automobile, a portable electronic device 210 associated with the operator 208. The portable electronic device is in communication with the on-board computers and at least one database such as a central database 212 in communication with the portable electronic device. The computers of the automobile are in communication with then portable electronic device either through a wired, e.g., USB, or wireless connection, e.g., WIFI or Bluetooth. Therefore, the computers and portable electronic devices include the transmitter and receiver components required to make this wireless connection.

Suitable portable electronic devices include laptop computers, tablet computers, personal digital assistants, netbooks, cellular phones including smartphones and customized interrogation computing systems. The on-board computers can also be interrogated by computing systems and telemetry systems located in a garage, at a tool booth or along a road or highway. When the portable electronic device is a smartphone, the data extractor utilizes all of the data collection systems, e.g., camera, microphone, accelerometers and gyroscopes, and communication systems of the smartphone. The portable electronic device is functionally connected to the onboard automobile computer systems and receives data from various sensors monitoring the function of vehicle systems. These data are then transmitted, preferably wirelessly, to a remote or central computer, for example using WiFi or cellular communication systems. The extractor can utilize external power sources or existing power sources of the automobile and portable electronic devices.

In addition to interrogating the onboard computing systems of the automobile in order to obtain the desired operational and maintenance information, the portable electronic devices can also be used to generate the operator specific operating conditions. These operating conditions can be generated in the automobile from which the maintenance and operational information is being obtained or in any automobile that is driven by the operator. The portable electronic device uses sensors such as accelerometers, navigation systems and global positioning systems, to analyze when, when and how the operator drives the automobile, or any automobile. This information, i.e., the automobile operating conditions attributable to the operating, are communicated to the central database and are used in formulating an operator profile. The operator profile is utilized in predicting maintenance costs, operating costs and automobile value.

The computing system includes at least one computer or server 214 containing a processing unit 220 in communication with the memory 212. All of the components of the computing system can be in communication through one or more networks 216 including local area networks and wide area networks. The computer 214 also includes a future value and operational cost prediction module 222 that uses at least one of the ownership and maintenance determinative factors and the operator characteristics to predict future value and operational costs for the automobile owned and operated by the operator. In one embodiment, the computer also includes a recommendations module 224 the provides a recommended maintenance regime and recommended modifications to the operator characteristics module that increase future value of the automobile, reduce maintenance costs for the automobile and reduce operational costs for the automobile owned and operated by the operator.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to apparatus (systems) and computer program products according to embodiments of the invention. It will be understood that each description and illustration can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the block diagram block or blocks.

The schematic illustrations and block diagrams in the Figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams, and combinations of blocks in the block diagrams, can be implemented by special purpose hardware-based systems that perform the specified functions or acts, or combinations of special purpose hardware and computer instructions.

It is to be understood that although a detailed description on cloud computing is provided, implementation of the teachings provided herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources, e.g., networks, network bandwidth, servers, processing, memory, storage, applications, virtual machines, and services, that can be rapidly provisioned and released with minimal management effort or interaction with a provider of the service.

This cloud model may include at least five characteristics, at least three service models, and at least four deployment models. The five characteristics are on-demand self-service, broad network access, resource pooling, rapid elasticity and measured service. Regarding on-demand self-service, a cloud consumer can unilaterally provision computing capabilities, such as server time and network storage, as needed automatically without requiring human interaction with the service's provider. Broad network access refers to capabilities that are available over a network and accessed through standard mechanisms that promote use by heterogeneous thin or thick client platforms, e.g., mobile phones, laptops, and PDAs. For resource pooling, the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction, e.g., country, state, or datacenter. Rapid elasticity refers to capabilities that can be rapidly and elastically provisioned, in some cases automatically, to quickly scale out and rapidly released to quickly scale in. To the consumer, the capabilities available for provisioning often appear to be unlimited and can be purchased in any quantity at any time. For measured service, cloud systems automatically control and optimize resource use by leveraging a metering capability at some level of abstraction appropriate to the type of service, e.g., storage, processing, bandwidth, and active user accounts. Resource usage can be monitored, controlled, and reported, providing transparency for both the provider and consumer of the utilized service.

The three service models are Software as a Service (SaaS), Platform as a Service (PaaS) and Infrastructure as a Service (IaaS). Software as a service provides the capability to the consumer to use the provider's applications running on a cloud infrastructure. The applications are accessible from various client devices through a thin client interface such as a web browser, e.g., web-based e-mail. The consumer does not manage or control the underlying cloud infrastructure including network, servers, operating systems, storage, or even individual application capabilities, with the possible exception of limited user-specific application configuration settings. Platform as a service provides the capability to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a service provides the capability to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components, e.g., host firewalls.

The Deployment Models are private cloud, community cloud, public cloud and hybrid cloud. The private cloud infrastructure is operated solely for an organization. It may be managed by the organization or a third party and may exist on-premises or off-premises. The community cloud infrastructure is shared by several organizations and supports a specific community that has shared concerns, e.g., mission, security requirements, policy, and compliance considerations. It may be managed by the organizations or a third party and may exist on-premises or off-premises. The public cloud infrastructure is made available to the general public or a large industry group and is owned by an organization selling cloud services. The hybrid cloud infrastructure is a composition of two or more clouds (private, community, or public) that remain unique entities but are bound together by standardized or proprietary technology that enables data and application portability, e.g., cloud bursting for load-balancing between clouds.

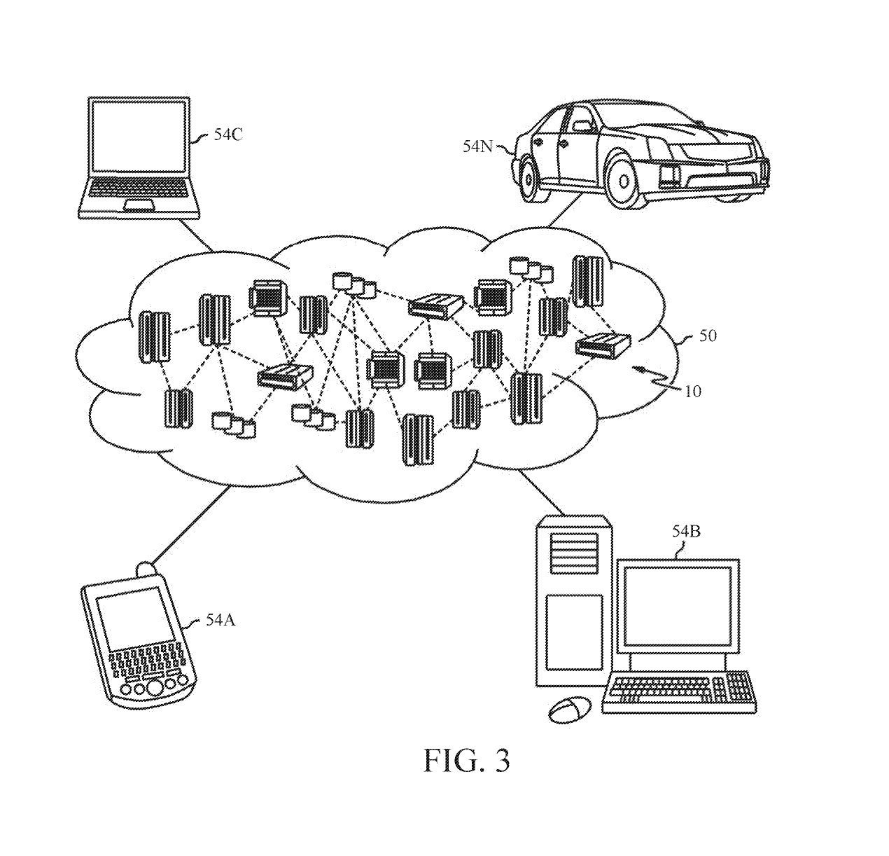

A cloud computing environment is service oriented with a focus on statelessness, low coupling, modularity, and semantic interoperability. At the heart of cloud computing is an infrastructure that includes a network of interconnected nodes. Referring now to FIG. 3, an illustrative cloud computing environment 50 is depicted. As shown, the cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection, e.g., using a web browser.

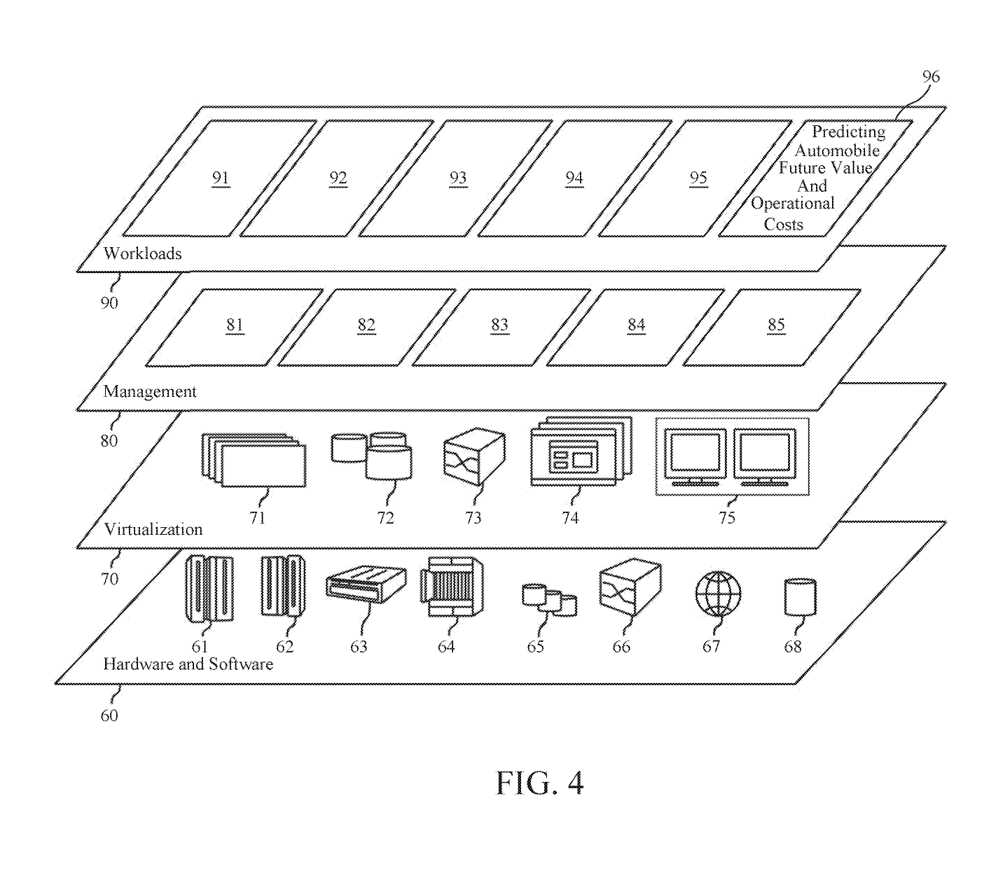

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided. A hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. A virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and predicting automobile future value and operational costs 96.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for predicting automobile future value and operational costs in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for predicting automobile future value and operational costs, the method comprising:
obtaining ownership and maintenance determinative factors for an automobile, the ownership and maintenance determinative factors comprising operational parameters and maintenance parameters affecting ownership costs and automobile value for the automobile;
obtaining an operator profile for an automobile operator describing automobile operating conditions attributable to the automobile operator; and
using at least one of the ownership and maintenance determinative factors and the operator profile to predict future value and operational costs for the automobile owned and operated by the operator.

2. The method of claim 1, wherein obtaining the ownership and maintenance determinative factors comprises obtaining ownership and maintenance determinative factors for the automobile and for individual components of the automobile.

3. The method of claim 1, wherein obtaining the ownership and maintenance determinative factors comprises associating at least one of a chronological vehicle age and a vehicle mileage with at least one ownership and maintenance determinative factor.

4. The method of claim 1, wherein the maintenance parameters comprise a history of warranty claims for the automobile, a history of factory recalls for the automobile, service records for the automobile, cost of components for the automobile, environmental conditions where the automobile is physically located, third-party reviews of the automobile, owner reviews of the automobile, data logs from computers and sensors contained in the automobile, reliability data or combinations thereof.

5. The method of claim 1, wherein the operational parameters comprise fuel consumption data, type of fuel, licensing costs, personal property taxes, insurance costs, vehicle inspection costs, scheduled maintenance or combinations thereof.

6. The method of claim 1, wherein the operator profile comprises demographic data, driving record, yearly mileage driven, average automobile speed, mean automobile speed, automobile speed profile, automobile acceleration profile, automobile breaking profile, gas pedal use, lane crossing and overtaking, geographical data, municipal data, percentage of highway miles, percentage of city miles, percentage of time spent in traffic, average number of occupants in the automobile or combinations thereof.

7. The method of claim 1, wherein:
obtaining ownership and maintenance determinative factors further comprises obtaining ownership and maintenance factors for a plurality of automobiles; and
using the ownership and maintenance determinative factors and the operator profile further comprises using the ownership and maintenance factors for the plurality of automobiles to predict future value and operational costs for each one of the plurality of automobiles owned and operated by the operator.

8. The method of claim 1, wherein:
obtaining the operator profile further comprises obtaining an operator profile for each one of a plurality of automobile operators describing automobile operating conditions attributable to each automobile operator; and
using the ownership and maintenance determinative factors and the operator profile further comprises using the operator profiles for the plurality of automobile operators to predict future value and operational costs for the automobile owned and operated by each one of the plurality of operators.

9. The method of claim 1, wherein:
at least one of obtaining ownership and maintenance determinative factors and obtaining the operator profile further comprises at least one of:
interrogating computers and sensors contained in the automobile using a portable electronic device; and
recording automobile operating conditions attributable to the operator in real time using the portable electronic device; and
using the portable electronic device to communicate data obtained from the computers and sensors and the automobile operating conditions to a database.

10. The method of claim 1, wherein using the ownership and maintenance determinative factors and the operator profile to predict future value and operational costs further comprises predicting future value and operational costs by at least one of automobile mileage and automobile age.

11. The method of claim 1, further comprising using the predicted future value and operational costs to decide whether to purchase the automobile, repair the automobile or dispose of the automobile.

12. The method of claim 1, further comprising using the ownership and maintenance determinative factors and the operator profile to provide a recommended maintenance regime and modification to the operator profile that increase future value of the automobile, reduce maintenance costs for the automobile and reduce operational costs for the automobile owned and operated by the operator.

13. A computer-readable storage medium containing a computer-readable code that when read by a computer causes the computer to perform a method for predicting automobile future value and operational costs, the method comprising:
obtaining ownership and maintenance determinative factors for an automobile, the ownership and maintenance determinative factors comprising operational parameters and maintenance parameters affecting ownership costs and automobile value for the automobile;
obtaining an operator profile for an automobile operator describing automobile operating conditions attributable to the automobile operator; and
using at least one of the ownership and maintenance determinative factors and the operator profile to predict future value and operational costs for the automobile owned and operated by the operator.

14. The computer-readable storage medium of claim 13, wherein:
the maintenance parameters comprise a history of warranty claims for the automobile, a history of factory recalls for the automobile, service records for the automobile, cost of components for the automobile, environmental conditions where the automobile is physically located, third-party reviews of the automobile, owner reviews of the automobile, data logs from computers and sensors contained in the automobile, reliability data or combinations thereof;
the operational parameters comprise fuel consumption data, type of fuel, licensing costs, personal property taxes, insurance costs, vehicle inspection costs, scheduled maintenance or combinations thereof; and
the operator profile comprise demographic data, driving record, yearly mileage driven, average automobile speed, mean automobile speed, automobile speed profile, automobile acceleration profile, automobile breaking profile, geographical data, percentage of highway miles, percentage of city miles or combinations thereof.

15. The computer-readable storage medium of claim 13, wherein:
at least one of obtaining ownership and maintenance determinative factors and obtaining the operator profile further comprises at least one of:
interrogating computers and sensors contained in the automobile using a portable electronic device; and
recording automobile operating conditions attributable to the operator in real time using the portable electronic device; and
using the portable electronic device to communicate data obtained from the computers and sensors and the automobile operating conditions to a database.

16. The computer-readable storage medium of claim 13, wherein using the ownership and maintenance determinative factors and the operator profile to predict future value and operational costs further comprises predicting future value and operational costs by at least one of automobile mileage and automobile age.

17. The computer-readable storage medium of claim 13, wherein the method further comprises using the predicted future value and operational costs to decide whether to purchase the automobile, repair the automobile or dispose of the automobile.

18. The computer-readable storage medium of claim 13, wherein the method further comprises using the ownership and maintenance determinative factors and the operator profile to provide a recommended maintenance regime and modification to the operator profile that increase future value of the automobile, reduce maintenance costs for the automobile and reduce operational costs for the automobile owned and operated by the operator.

19. A computing system for predicting automobile future value and operational costs, the computing systems comprising:
a hardware memory comprising a database comprising ownership and maintenance determinative factors for an automobile, the ownership and maintenance determinative factors comprising operational parameters and maintenance parameters affecting ownership costs and automobile value for the automobile, and an operator profile for an automobile operator describing automobile operating conditions attributable to the automobile operator;
a processing unit in communication with the memory; and
a future value and operational cost prediction module to use at least one of the ownership and maintenance determinative factors and the operator profile to predict future value and operational costs for the automobile owned and operated by the operator.

20. The computing system of claim 19, further comprising a vehicle maintenance and operation extractor comprising:
computers and sensors contained in the automobile to record operational parameters and maintenance parameters for the automobile;
a portable electronic device to interrogate the computers and sensors to obtain the recorded operational parameters and maintenance parameters and to record automobile operating conditions attributable to the operator in real time using the portable electronic device; and
a central database in communication with the portable electronic device to receive the operational parameters, maintenance parameters and operating conditions.
